(19) United States
(12) Patent Application Publication
(10) Pub. No.: US 2017/0323468 A1
(43) Pub. Date: Nov. 9, 2017

(54) ANIMATION TECHNIQUES

(71) Applicant: Gerald Patrick Conn, Cardiff (GB)

(72) Inventor: Gerald Patrick Conn, Cardiff (GB)

(21) Appl. No.: 15/590,155

(22) Filed: May 9, 2017

(30) Foreign Application Priority Data
May 9, 2016 (GB) 1608015.2
May 8, 2017 (GB) 1707316.4

(51) Int. Cl. G06T 13/80; G06F 3/0488; G06F 3/0484

(52) U.S. Cl. CPC G06T 13/80; G06F 3/04845; G06F 3/04883

(57) ABSTRACT

A method of digitally making moving picture animation films formed by manipulation of a computer touch screen, the method including the steps of displaying on the screen an image of an array of particulates, such as sand, manipulating the particulates to form a first image, storing a copy of the first image onto computer memory, thereafter altering the first image on the display screen to form a second image and again storing a copy of it to memory, the sequence continuing until a required number of images have been made and stored, and thereafter replaying the stored images in sequence to form a moving picture animation film.

This invention relates to moving picture animation techniques of the type where sequences of individually drawn images, each slightly different to the next, are replayed at speed to form a moving picture such as a cartoon film.

It is well known that moving picture animations are very time consuming to make because each image in the sequence has to be individually drawn or otherwise manipulated. Although the process has been automated by the introduction of computer generated animation it is very apparent to the viewer of the resulting film that the images have not been created by hand and are therefore not considered as aesthetically pleasing to watch.

Another prior animation technique involves an under-lit flat glass plate onto which particles of sand are placed which are then manipulated to form an image. The image is then photographed and the sand is manipulated slightly in sequence to build up a series of photographs which, when replayed in quick succession give the illusion of movement, as well as being an obviously hand-crafted animation film. However, the procedure for producing the film is labour intensive and time-consuming, also requiring studio apparatus which is not readily portable, making the technique only suitable for professional film makers with a budget sufficient to finance the production.

The present invention is derived from the realisation that the creation of hand drawn animation films can be simplified to the extent that considerable time can be saved through the use of a computer having a touch-sensitive screen, such as a tablet computer or iPad.

According to a first aspect of the invention there is provided a digital method of making moving picture animation films formed by manipulation of computer touch screen, the method including the steps of displaying on the screen an image of an array of particulates, such as sand, manipulating the particulates to form a first image, storing a copy of the first image onto computer memory, thereafter altering the first image on the display screen to form a second image and again storing a copy of it to memory, the sequence continuing until a required number of images been made and stored, and thereafter replaying the stored images in sequence to form a moving picture animation film.

With this arrangement animation films of varying levels of detail can be made, making it suitable for use by professional or non-professional illustrators, including children, the level of detail being dictated by e.g. the size of the particulates displayed on the screen and/or the time taken to form each image before it is stored.

Conveniently, the method also includes the step of importing onto the screen a line sketch or line test image to assist in the creation of the first image in the sequence or of other line test images at suitable other points thereafter whereby to reduce the overall time taken to make the film or increase the perceived quality of the film when being viewed. The opacity of the imported line sketch can conveniently be adjusted with e.g. a slider tab so that a comparison between the particular image and the line drawing can be more easily made, thereby making it easier for the operator to view both images simultaneously.

Features of the array of particulates displayed on the screen may be varied as well as their size, such as their shape, colour, opacity and number. In addition, the computer display may also be programmed to reflect the size of the users fingers, thereby making it suitable for use by children and adults alike.

In a refinement to the method of the invention, the computer is programmed to convert a photographic image or individual frames of a video into a corresponding particulate image to produce animation sequences where the particulates replace the pixels to form an essentially grainy animation sequence based upon digital photographic images. This can be conveniently achieved by uploading a photographic image or video file onto the computer for the purposes of making an automatic analysis of the tonal range of each photographic image and to then convert this information into a grainy monochrome version in which the digitally created particulates replace the tones in each photographic image. The result provides an impressionistic image corresponding to each photograph which nevertheless closely resembles hand drawn images in which the computer touch screen is manipulated by a user to produce and store in sequence individual frames corresponding to each photograph. With such an arrangement, which may be used partially or wholly to create a moving picture animation film. a considerable amount of time can be saved as compared to the user creating individual images in sequence by hand.

In a further refinement to the invention the computer programme provides a bridging process enabling the user to automatically fill in frames bridging between certain key images created by hand on the touch screen. Thus, in an initial animation sequence involving a total of nine images commencing with the subject looking right and ending with the subject looking left the sequence can be considerably shortened whereby the computer captures to memory the first and last images and a third, intermediate, image shown the subject looking forward, whereafter the programme predicts what the intermediate frames would look like and inserts them automatically, thus again saving a considerable amount of time in creating the entire sequence.

In a still further refinement the computer is programmed with an archive of pre-dawn elements, such as mouth shapes forming individual letter sounds, which can be added onto a main animation drawing as required to represent different syllables of audio dialogue. This time-saving technique can be further improved by providing the artist with a visual indication of the audio dialogue, such as a waveform indicating varying sound levels.

According to a second aspect of the invention there is provided a touch-screen computer programmed to carry out the method of the invention in response to input from a user thereof.

According to a third aspect of the invention there is provided a moving picture animation film made in accordance with the method of the invention.

The finished animated sequences may conveniently be outputted in the firm of a series of still images of alternately as a movie file in a selection of file sizes. Additionally, these video and picture files as well as the project files themselves can be exported to a cloud based storage format such as Dropbox which will retain storage capacity on the user computer/tablet as well as allowing other users to access the material.

According to a fourth aspect of the invention there is provided a computer programme operable to perform the method of the invention under user input via a touch-screen computer.

Preferably, the computer exports the animation sequence using a process of randomisation of the shape of the individual digital particles, thereby more closely following the appearance of real particles, such as sand grains. This particle enhancement feature is particularly noticeable when projected onto a large screen such as a cinema screen.

The invention will now be described, by way of example only, with reference to the accompanying drawings in which:

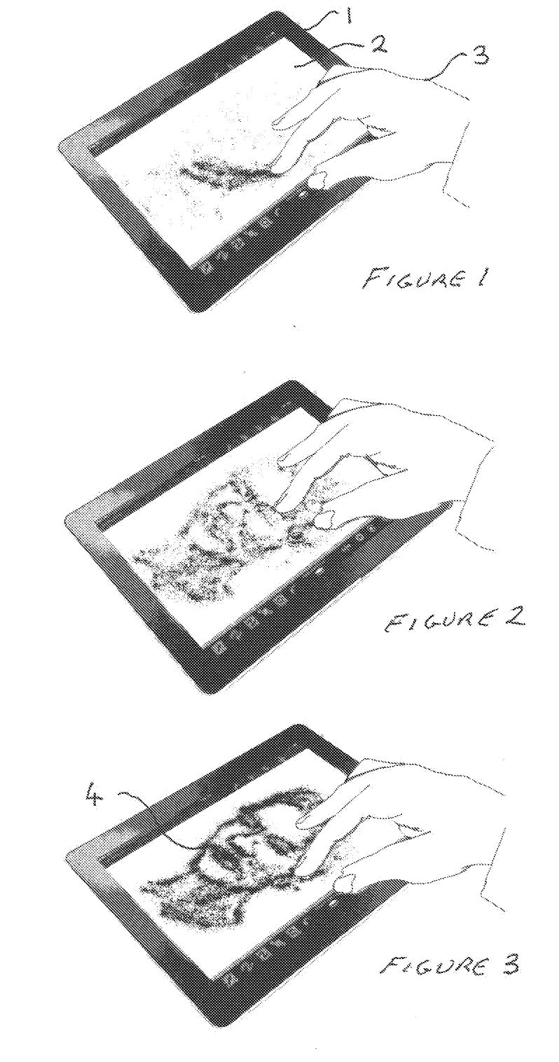

FIG. 1 shows an initial stage of composing an image on a computer touch screen.

FIG. 2 shows an intermediate stage of composing the image of FIG. 1,

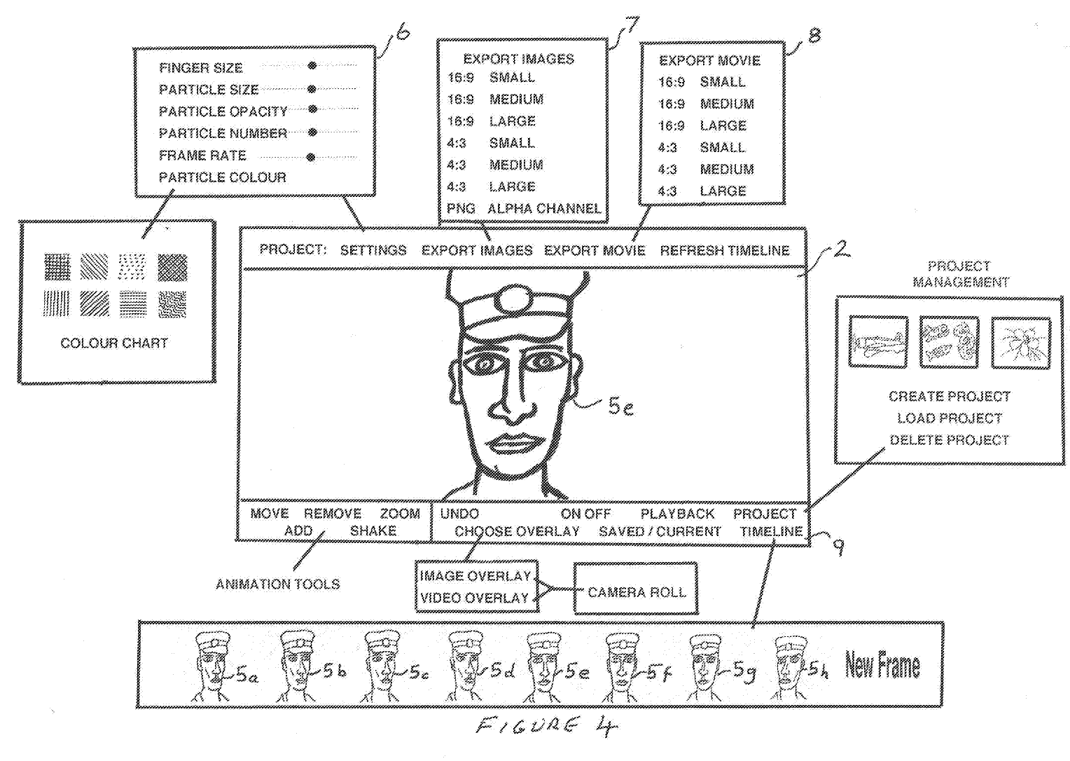

FIG. 3 shows a finished stage of composing the image of FIG. 1, and

FIG. 4 is a schematic arrangement of the screen and toolbars used or useable for forming the images of FIGS. 1 to 3.

FIG. 1 shows a conventional tablet computer or iPad 1 having a touch-sensitive display screen 2 operable by the fingers of a hand 3 of a user of the device. On the display screen 2 is an initially even array of particulates resembling e.g. particles of sand, which can be gathered together by the fingers of the user in the manner as indicated to begin forming an image.

FIG. 2 shows that the image being formed is that of a human head which is shown substantially completed in FIG. 3. The image may, of course, by of any desired subject whereby the accumulation of computer-generated particulates into various lines and areas of shading is sufficient to form a recognisable image, which is then captured into the memory of the computer 1. Once an image has been created, copied and subsequently stored it can then be manipulated by hand 3 to form a slightly different image corresponding to a successive frame in a moving picture animation comprising a continuous sequence of successively altered images or, as required, when one sequence has ended a fresh sequence of a different set of images can be constructed, with each set of sequencer then being combined as required to form a moving picture animation film.

FIG. 4 shows a schematic arrangement of the toolbars and menus available for altering the content of the display screen 2 of the computer 1. In the main image the central character 5 is shown facing forwards but is only part of a sequence along with 8 other similar images 5a to 5j in which the subject initially appears looking to the right and then moves from that position to one in which it is looking to the left, thereby mimicking individual frames or photographs which, when replayed in sequence at a suitable speed appear to the viewer to provide a constantly moving image. The image itself can be manipulated in a variety of ways by pre-selection from a menu of settings 6 which include a choice of finger size of the image creator, particle size, particle opacity, particle number i.e. the number of particles available for viewing and manipulation on the screen 2, frame rate or speed i.e. the time difference between presentation of one frame and its next succeeding frame, and particle colour, as chosen from a suitable colour chart.

Individual images may be exported in various formats via an export menu 7, and collated images which combine to form an animation film can be exported in various formats via an export movie menu 8.

The lower end of a tool bar 9 includes various options to be expected in this kind of digital processing of images by which to produce a semi-realistic film in what is effectively an impressionist style.

As will be appreciated, although the method of the invention lends itself to the creation of an animation film via a single user of a computer tablet, it also lends itself to sharing film production amongst a number of users, each having access to a suitably programmed computer with a touch-sensitive screen, effectively allowing simultaneous production of different parts of an animation film which are then composited together for final viewing. Thus, professional graphic artists at different geographical locations can easily collaborate to produce an animation film and, equally, classrooms with an adequate supply of touch-screen computers can allow its pupils to cooperate in producing selected portions of an animation film. In either event, by allowing the graphic artist or pupil, as the case may be, to make individual artistic contribution to the film, interest in this technique is heightened. A variety of film-making techniques can also be improved along with improving the understanding of the capabilities of computers to facilitate learning of such tasks.

Although the invention is intended to be put into effect by means of a downloadable computer programme or app onto a standard computer tablet or IPhone, it will be appreciated that it may instead be preloaded into such devices.

The invention is also not limited to the use of an initially uniform display of particulates on the display screen but may, instead, provide a pre-selected view of a chosen subject in which the particulates emphasise the general shape of the subject as a starting point before the image is manipulated as part of a sequence of images forming the finished animation film. Similarly, it will be understood that where the chosen size of the particulates is easily discernable visually, the resulting imagery will be consesquentially coarse, but where the chosen size of the particulates is relatively fine each particulate may not be readily discernable such that the overall image corresponds to a line drawing and hence the resulting animation film corresponds much more closely to a conventionally drawn cartoon film. In a further refinement to this concept, particularly where fine detail is required of each image, a stylus may be used instead of e.g. a finger, in order to collect and collate particulates on the screen to form all or parts of images, where fine detail is required, such as for the eyes of a portraiture. The stylus itself may also be in the form of a brush tending to mimic the swiping movement of a finger where, in each case, the effect is to give a feeling of the image being freely drawn rather than computer generated. This effect can be increased by utilising a zoom function by which particular parts of the display screen 2 may be manipulated in finer detail than other such parts.

The invention therefore provides a useful additional technique to conventional animation film making where physical manipulation of each image is generally required, but without the use of computer generated imaging techniques for composing the whole of the film.

1. A digital method of making moving picture animation films formed by manipulation of a computer touch screen, the method including the steps of displaying on the screen an image of an array of particulates, such as sand, manipulating the particulates to form a first image, storing a copy of the first image onto computer memory, thereafter altering the first image on the display screen to form a second image and again storing a copy of it to memory, the sequence continuing until a required number of images have been made and stored, and thereafter replaying the stored images in sequence to form a moving picture animation film.

2. A method according to claim 1 further including the step of importing onto the screen a line sketch or line test image to assist in the creation of the first image in the sequence or of other line test images at suitable other points thereafter.

3. A method according to claim 1 in which the features of the array of particulates displayed on the screen are varied as well as their size, such as their shape, color, opacity and number.

4. A method according to claim 1 in which the computer display is programmed to reflect the size of the users fingers.

5. A method according to claim 1 in which the computer is programmed to convert a photographic image or individual frames of a video into a corresponding particulate image to produce animation sequences where the particulates replace the pixels to form an essentially grainy animation sequence based upon digital photographic images.

6. A method according to claim 5 in which the photographic image or video file is uploaded onto the computer for making an automatic analysis of the tonal range of each photographic image and then converting this information into a grainy monochrome version in which the digitally created particulates replace the tones in each photographic image.

7. A method according to claim 5 in which the computer touch screen is manipulated by a user to produce and store in sequence individual frames corresponding to each photograph to thereafter create a moving picture animation film.

8. A method according to claim 1 in which the computer is programmed to provide a bridging process enabling the user to automatically fill in frames bridging between certain key images created by hand on the touch screen.

9. A method according to claim 1 in which the computer is programmed with an archive of pre-drawn elements.

10. A method according to claim 9 in which mouth shapes from the archive forming individual letter sounds are added onto a main animation drawing as required to represent different syllables of audio dialogue.

11-13. (canceled)
